(19) United States
(12) Patent Application Publication
(10) Pub. No.: US 2014/0224190 A1
(43) Pub. Date: Aug. 14, 2014

(54) CLASP

(71) Applicant: Michael Neville Waters, Townsville (AU)

(72) Inventor: Michael Neville Waters, Townsville (AU)

(21) Appl. No.: 14/255,501

(22) Filed: Apr. 17, 2014

Related U.S. Application Data
(63) Continuation-in-part of application No. 12/936,283, filed on Apr. 19, 2011, now Pat. No. 8,739,742.

(30) Foreign Application Priority Data
Apr. 4, 2008 (AU) 2008201529

(51) Int. Cl. A44B 11/06; A01K 27/00

(52) U.S. Cl. CPC A44B 11/06; A01K 27/001
USPC 119/863; 24/492

(57) ABSTRACT

A clasp having:
a body defining at least one passageway extending from an inlet at a first end of the body to an outlet at a second, opposite end of the body, the second end of the body adapted to secure an elongate member to the body of the clasp, said body comprising a bottom wall, one or more walls extending upward from said bottom wall, the interior of the one or more walls serving to define the passageway,
an engagement portion pivotally mounted across the body and adapted to engage the elongate member when located in said at least one passageway,
   an actuation portion in communication with the engagement portion and biased into an engaged condition,
wherein actuation of said actuation portion causes the engagement portion to disengage from the elongate member against the biasing force.

### CROSS-REFERENCE TO RELATED APPLICATIONS

This application is a continuation-in-part of U.S. National Stage application Ser. No. 12/936,283, filed Apr. 19, 2011, in the U.S. Patent and Trademark Office, which claims the benefit of International Application No. PCT/AU2009/000413, filed Apr. 3, 2009, which claims the benefit of Australian Application No. 2008201529, filed Apr. 4, 2008, in the Australian Patent Office. All disclosures of the document(s) named above are incorporated herein by reference.

### BACKGROUND OF THE INVENTION

1. Field of the Invention

The present invention relates to a clasp. In particular, the present invention relates to a clasp for use with such devices as collars or belts.

2. Description of the Related Art

Clasps are used for a wide variety of applications, such as collars for animals, safety belts (or other safety devices), clothing and so on. However, existing clasps suffer from the drawback that, if the same device is used by two different people, it will most likely need to be adjusted so as to fit the second person. This is fiddly, time-consuming and may result in, for instance, excess lengths of belt dangling from the device which is both unsightly and potentially hazardous.

Similarly, due to the nature of existing clasps, animal collars or belts for clothing are constructed in particular sizes, meaning that as a person or animal grows, the belt or collar must either be adjusted manually (e.g. by adding additional holes to the belt or collar) or replaced if the belt or collar becomes to small for the person or animal.

Thus, there would be an advantage if it were possible to provide a clasp which allowed a belt, collar or other similar device to be easily and quickly adjusted when the same device is used by people or animals of different size.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### SUMMARY OF THE INVENTION

It is an object of the present invention to provide a clasp which may overcome at least some of the abovementioned disadvantages, or provide a useful or commercial choice.

In one aspect, the invention resides broadly in a clasp having a body defining at least one passageway extending at least partially therethrough, engagement means pivotally mounted across the body and adapted to engage an object located in said at least one passageway, and actuation means in communication with the engagement means and biased in the engaged condition, wherein actuation of said actuation means causes the engagement means to disengage from the object against the biasing force.

In use, the clasp of the present invention will be used in association with an elongate flexible member. Importantly, the clasp of the invention may be fixed to a portion of the member or alternatively, may be at least temporarily fixed in position via the engagement means only. The clasp may be removable from the member entirely and the member may be moved through the at least one passageway with or without restriction apart from the engagement means.

Typically, the clasp will be used in one of two main situations, namely, more or less permanently attached to an end of the elongate member with another portion of the member engaged by the engagement means or alternatively, as a clasp which is fixed in position by the engagement means along the length of the elongate member.

The body of the clasp may be of any suitable shape, size or configuration. In some embodiment of the invention, the body of the clasp comprises one or more walls, the interior of the one or more walls of the body serving to define at least one passageway extending at least partially therethrough. In a preferred embodiment of the invention, the body of the clasp comprises a bottom wall and a pair of sidewalls extending therefrom.

Preferably, the body of the clasp comprises one or more inlets into which an object may be inserted. In some embodiments of the invention, the body of the clasp further comprises one or more outlets. Thus, in these embodiments of the invention, the at least one passageway extends entirely through the body of the clasp, with the at least one inlet defining one end of the passageway and the at least one outlet defining a second end of the passageway. Whilst the passageway may be of any suitable configuration (curved, tortuous or the like), it is preferred that the passageway is substantially straight.

In some embodiments of the present invention, the one or more inlets may be provided with guide means in order to assist a user with correctly inserting an object into the passageway. The guide means may be of any suitable size, shape and configuration. The guide means may be constructed as a single piece or may comprise a number of individual components. The guide means may be formed integrally with the body of the clasp, or may be formed separately and attached to the body of the clasp using any suitable technique.

Preferably, the guide means is located adjacent said one or more inlets and extends at least partially across said one or more inlets. In some embodiments of the invention, the guide means may extend entirely across the one or more inlets and be adapted for either permanent or temporary connection to each of the pair of sidewalls.

In a specific embodiment of the invention, the guide means comprises an elongate member in the form of a plate. In this specific configuration of the invention, a first end of the plate is located at an outer edge of the body such that the body and the plate together define the inlet of the clasp. The first end of the plate extends between upper ends of the sidewalls of the body.

It is envisaged that the plate will extend from the outer edge of the body into the interior of the body. In this configuration, the plate is located at an angle to the bottom wall such that the passageway formed between the plate and the bottom wall narrows along the length of the plate as the plate extends into the body. In embodiments of the invention in which the plate is substantially flat, it is envisaged that the passageway may narrow at a uniform rate along the length of the plate. Alternatively, the plate may be curved, meaning that the rate at which the passageway narrows may vary along the length of the plate.

In some embodiments of the invention, the guide means may further extend at least partially into the passageway. In a preferred embodiment, as it extends into the passageway the guide means may be disposed at an angle to the bottom wall of the passageway, such that the passageway tapers or narrows along at least a portion of its length between the one or more inlets and the one or more outlets. The guide means may be straight, curved or a combination thereof as it extends into the body of the clasp.

The actuation means may be of any suitable form. As previously stated, the actuation means is in communication with the engagement means, and the communication between the actuation means and the engagement means may be achieved using any suitable technique. The actuation means may communicate either directly or indirectly with the engagement means. For instance, the actuation means may be located remotely from the engagement means (or even remotely from the clasp), or the actuation means and the engagement means may be physically connected to one another, either temporarily or permanently.

In some embodiments of the invention, the actuation means comprises a lever, button, switch, latch, or the like. The actuation means may be located remotely from the clasp or may be mounted permanently or temporarily to the body of the clasp. The actuation means may be formed integrally with the body of the clasp or may be formed separately and subsequently mounted thereto using any suitable technique. In some embodiments of the invention, at least a portion of the actuation means may form at least a portion of an upper wall of the body of the clasp.

In a preferred embodiment of the invention, the actuation means are biased in the engaged condition. By this it is meant that, when the actuation means is not being actuated, the actuation means are biased such that the engagement means are in position to engage an object. Preferably, when the engagement means are in position to engage an object, the engagement means are located within the passageway. In some embodiments of the invention, when the engagement means are located in the passageway (i.e. when the actuation means is in the biased condition), the passageway may be at least partially blocked by the engagement means. Preferably, when the engagement means are located in the passageway, an object cannot pass through the passageway due to the obstacle caused by the location of the engagement means. The actuation means may be biased in this condition using any suitable biasing means, such as a compressible tube or the like. In a preferred embodiment of the invention, however, the biasing means comprises one or more springs.

In a preferred embodiment of the invention, the biasing force of the biasing means may be overcome by manual pressure applied by a user's fingers or hands. However, depending on the application to which the invention is applied, it may be preferable that a greater (or lesser) force than this is required to overcome the biasing force and actuate the actuation means.

In some embodiments of the invention, actuation of the actuation means may result in the engagement means moving such that it no longer obstructs the passageway. In this way, upon actuation of the actuation means, an object may be inserted into, and pass through, the passageway. When the actuation of the actuation means is released, the actuation means are biased so as to return the engagement means to the engaged condition within the passageway, whereupon, if an object has been inserted into the passageway, the engagement means engages with said object to retain it in place. In some embodiments of the invention, this movement of the engagement means is achieved by mounting the engagement means and the actuation means so as to be pivotally mounted to the body of the clasp. Thus, actuation of the actuation means causes the engagement means to pivot about a pivot point such that the engagement means is pivoted out of the passageway.

In some embodiments of the invention, the actuation means may be provided with one or more indicia to instruct a user in how to actuate the actuation means. The one or more indicia may be in the form of words, letters, numbers, symbols, pictures, colours or any combination thereof.

The engagement means may be of any suitable form to create a sufficient engagement between the engagement means and the object to prevent the object from moving without the engagement means being disengaged. The physical engagement may be achieved using any suitable technique such as by abutting, a frictional engagement, a pin and slot arrangement, a clamping motion or a combination thereof.

The engagement means may be provided with one or more projections (teeth, hooks, spikes or the like), an adhesive, Velcro or the like (or any combination thereof) that may physically engage and hold the object during use.

In some embodiments of the invention, the engagement means may comprise an array of projections. The array of projections may be provided on a member which extends transversely across at least a portion of the passageway. When the engagement means is in the engaged position, the array of projections may extend at least partially into the passageway. In this way, the array of projections may engage with at least a portion of the width of an object located in the passageway.

In a preferred embodiment of the invention, the actuation of the actuation means may cause the array of projections to move such that the array of projections does not project into the passageway. In this manner, the array of projections may be disengaged from the object located in the passageway so that the object may be removed from the passageway or have its position adjusted. In addition, by moving the array of projections out of the passageway, an object may be inserted into the passageway if required.

In a preferred embodiment of the invention, the member on which the array of projections is provided may be in communication with the actuation means. Preferably, the member is connected, either fixedly or removably, to the actuation means.

In a preferred embodiment of the invention, the clasp may be provided with attachment means. The attachment means may be of any suitable form, shape, size or configuration. The attachment means may be adapted to allow a item to be permanently or temporarily attached thereto (such as an animal leash, identification tag or the like)

The object located in the passageway may be any suitable object. In some embodiments of the invention, however, the object comprises one or more elongate members, such as a belt or strap for clothing, a belt or strap for safety equipment (e.g. a vehicle or aeroplane seatbelt, a safety harness strap or the like), a cord, rope, chain or a collar for an animal and so on. Alternatively, in situations in which the clasp is held in a fixed position, the attachment means may be used to attach the clasp to a any suitable fixed object. The attachment means may comprise a hook, loop, screw, bolt, clamp, projection or the like, or any combination thereof.

The clasp may be constructed from any suitable material, such as metal, plastic, fiberglass or the like. The individual components of the clasp may be constructed from the same, or different materials. The clasp may be manufactured in a variety of sizes or shapes, depending on the application in which it is to be used.

In another aspect, the invention resides broadly in a collar, the collar comprising at least one elongate member and a clasp having a body defining at least one passageway extending at least partially therethrough, engagement means pivotally mounted across the body and adapted to engage an object located in said at least one passageway, and actuation means in communication with the engagement means and biased in the engaged condition, wherein actuation of said actuation means causes the engagement means to disengage from the object against the biasing force.

Preferably, the elongate member comprises a strap (such as a metal, fabric, plastic or leather strap), rope, cord, belt, chain or the like. Preferably, the elongate member comprises the portion of the collar that is placed around the neck of the wearer. Although the term “collar” has been used in this context, the skilled addressee will understand that the collar could equally be applied to a wearer's arm, leg, torso, waist, head or any other suitable location.

In a most preferred embodiment of the invention, the collar is a collar for an animal.

In yet another aspect, the invention resides broadly in a method of attaching a collar to an animal, the method comprising the steps of actuating an actuation means located on a clasp provided on said collar, inserting an elongate portion of the collar into the clasp, releasing the actuation means when the elongate portion has been inserted a sufficient distance into the clasp, wherein releasing the actuation means causes an engagement means to engage with the elongate portion, thereby preventing the elongate portion from moving when in use.

In another aspect, the invention resides broadly in a clasp having

a body defining at least one passageway extending from an inlet at a first end of the body to an outlet at a second, opposite end of the body, the second end of the body adapted to secure an elongate member to the body of the clasp, said body comprising a bottom wall, one or more walls extending upward from said bottom wall, the interior of the one or more walls serving to define the passageway,

an engagement portion pivotally mounted across the body and adapted to engage the elongate member when located in said at least one passageway,

an actuation portion in communication with the engagement portion and biased into an engaged condition,

wherein actuation of said actuation portion causes the engagement portion to disengage from the elongate member against the biasing force.

The actuation portion may be of any suitable form. As previously stated, the actuation portion is in communication with the engagement portion, and the communication between the actuation portion and the engagement portion may be achieved using any suitable technique.

The actuation portion may communicate either directly or indirectly with the engagement portion. For instance, the actuation portion may be located remotely from the engagement portion (or even remotely from the clasp), or the actuation portion and the engagement portion may be physically connected to one another, either temporarily or permanently.

In some embodiments of the invention, the actuation portion comprises a lever, button, switch, latch, or the like. The actuation portion may be located remotely from the clasp or may be mounted permanently or temporarily to the body of the clasp. The actuation portion may be formed integrally with the body of the clasp or may be formed separately and subsequently mounted thereto using any suitable technique. In some embodiments of the invention, at least a portion of the actuation portion may form at least a portion of an upper wall of the body of the clasp.

In a preferred embodiment of the invention, the actuation portion is biased into the engaged condition. By this it is meant that, when the actuation portion is not being actuated, the actuation portion is biased such that the engagement portion is in position to engage the elongate member. Preferably, when the engagement portion is in position to engage the elongate member, the engagement portion is located within the passageway.

In some embodiments of the invention, when the engagement portion is located in the passageway (i.e. when the actuation portion is in the biased condition), the passageway may be at least partially blocked by the engagement portion. Preferably, when the engagement portion is located in the passageway, the elongate member cannot pass through the passageway due to the obstacle caused by the location of the engagement portion. The actuation portion may be biased into this condition using any suitable biasing member, such as a compressible tube or the like. In a preferred embodiment of the invention, however, the biasing member comprises one or more springs.

In a preferred embodiment of the invention, the biasing force of the biasing member may be overcome by manual pressure applied by a user's fingers or hands. However, depending on the application to which the invention is applied, it may be preferable that a greater (or lesser) force than this is required to overcome the biasing force and actuate the actuation portion.

In some embodiments of the invention, actuation of the actuation portion may result in the engagement portion moving such that it no longer obstructs the passageway or only partially obstructs the passageway. In this way, upon actuation of the actuation portion, the elongate member may be inserted into, and pass through, the passageway. When the actuation of the actuation portion is released, the actuation portion is biased so as to return the engagement portion to the engaged condition within the passageway, whereupon, if the elongate member has been inserted into the passageway, the engagement portion engages with said elongate member to retain it in place. In some embodiments of the invention, this movement of the engagement portion is achieved by mounting the engagement portion and the actuation portion so as to be pivotally mounted to the body of the clasp. Thus, actuation of the actuation portion causes the engagement portion to pivot about a pivot point such that the engagement portion is pivoted out of the passageway. In embodiments of the invention in which the actuation portion and the engagement portion are operatively associated with one another, actuation of the actuation portion results in pivotal movement of both the engagement portion and the actuation portion about the pivot point.

The pivot point may be located at any suitable location relative to the actuation portion and/or the engagement portion. In a preferred embodiment of the invention, a pivot pin may be provided at the pivot point about which the engagement portion pivots. Preferably, the pivot pin may be attached to at least one wall of the body so that the engagement portion pivots about the stationary pivot pin. In this embodiment of the invention, it is envisaged that the pivot pin may be attached to opposed walls of the body, and preferably opposed walls extending upwardly from the bottom wall of the body. In some embodiments of the invention, the pivot pin may be at least partially surrounded by the actuation portion. In a preferred embodiment of the invention, the actuation portion may be provided with a passage therethrough into which the pivot pin may be inserted for attachment to opposed walls of the body.

In some embodiments of the invention, the actuation portion may be provided with one or more indicia to instruct a user in how to actuate the actuation portion. The one or more indicia may be in the form of words, letters, numbers, symbols, pictures, colors, a thumb pad or any combination thereof.

The engagement portion may be of any suitable form to create a sufficient engagement between the engagement portion and the elongate member to prevent the elongate member from moving without the engagement portion being disengaged. The physical engagement may be achieved using any suitable technique such as by abutting, a frictional engagement, a pin and slot arrangement, a clamping motion or a combination thereof.

The engagement portion may be provided with one or more projections (teeth, hooks, spikes or the like), an adhesive, Velcro or the like (or any combination thereof) that may physically engage and hold the elongate member during use.

In some embodiments of the invention, the engagement portion may comprise an array of projections. The array of projections may be provided on a member which extends transversely across at least a portion of the passageway. When the engagement portion is in the engaged position, the array of projections may extend at least partially into the passageway. In this way, the array of projections may engage with at least a portion of the width of the elongate member located in the passageway.

In a preferred embodiment of the invention, the actuation of the actuation portion may cause the array of projections to move such that the array of projections does not project into the passageway. In this manner, the array of projections may be disengaged from the elongate member located in the passageway so that the elongate member may be removed from the passageway or have its position adjusted. In addition, by moving the array of projections out of the passageway, the elongate member may be inserted into the passageway past the engagement portion if required.

In a preferred embodiment of the invention, the member on which the array of projections is provided may be in communication with the actuation portion. Preferably, the member is connected, either fixedly or removably, to the actuation portion.

In a preferred embodiment of the invention, the actuation portion is located towards, at or adjacent the first end of the body of the clasp (i.e. towards the inlet). In addition, it is preferred that the engagement portion is located towards, at or adjacent the second end of the body of the clasp (i.e. towards the outlet).

In a preferred embodiment of the invention, the clasp may be provided with an attachment portion. The attachment portion may be of any suitable form, shape, size or configuration. The attachment portion may be adapted to allow an item to be permanently or temporarily attached thereto (such as an animal leash, identification tag or the like). Alternatively, in situations in which the clasp is held in a fixed position, the attachment portion may be used to attach the clasp to a any suitable fixed object. The attachment portion may comprise a hook, loop, screw, bolt, clamp, projection or the like, or any combination thereof.

The elongate member may be of any suitable form. In some embodiments of the invention, however, the elongate member comprises one or more belts or straps for clothing, a belt or strap for safety equipment (e.g. a vehicle or aeroplane seatbelt, a safety harness strap or the like), a belt or strap for a vehicle tie-down (such as a truck or the like) a cord, rope, chain or a collar for an animal and so on.

The clasp may be constructed from any suitable material, such as metal, plastic, fiberglass or the like. The individual components of the clasp may be constructed from the same, or different materials. The clasp may be manufactured in a variety of sizes or shapes, depending on the application in which it is to be used.

In some embodiments of the invention, the bottom wall of the body may be substantially continuous. In this embodiment of the invention, a substantially continuous bottom wall ensures that the elongate member must pass through the inlet at the first end of the body and exit the clasp through the outlet located at the second end of the body.

It will be understood that the term “substantially continuous” is intended to mean that the bottom wall is not provided with apertures large enough for the elongate member to pass through. However, the bottom wall may still be provided with one or more apertures therein that are not large enough for the elongate member to pass through. For instance, the bottom wall may be provided with one or more apertures therein through which one or more securing members may pass to secure the elongate member to the body. The securing members may be of any suitable form, although in a preferred embodiment the securing members may comprise one or more mechanical fasteners, such as bolts, screws, rivets, nails or the like, or a combination thereof. In this embodiment of the invention it is envisaged that the elongate member may be provided with one or more apertures therethrough that may be aligned with the one or more apertures in the bottom wall to allow a securing member to pass through the aligned apertures and secure the elongate member to the body.

Alternatively, the bottom wall of the body may be non-continuous. However, in order to ensure that the elongate member passes through the inlet at the first end of the body and exits the clasp through the outlet located at the second end of the body, at least a portion of the bottom wall may be shaped so as to guide the elongate member along the passageway and prevent it from exiting the clasp through an aperture in the bottom wall. In this embodiment of the invention, at least a portion of the bottom wall may be provided at an angle to the remainder of the bottom wall so as to direct the elongate member along the passageway. The at least a portion of the bottom wall may be provided at any suitable angle to the remainder of the bottom wall, although in a preferred embodiment of the invention the at least a portion of the bottom wall may be angled into the passageway so as to ensure that the elongate member is directed through the passageway.

In this embodiment of the invention, it is envisaged that the end of the elongate member to be secured to the body may pass through the aperture to form a loop. The looped portion of the elongate member may then be secured to itself using one or more securing members. Once secured, the elongate member is effectively secured to the body of the clasp.

In some embodiments of the invention, the clasp may further be provided with a guide portion. Preferably, the guide portion is adapted to assist in guiding the elongate member through the passageway, thereby improving the ease with which the clasp may be used. The guide portion may be of any suitable form. However, in a preferred embodiment of the invention, the guide portion may be associated with the actuation portion. Thus, in this way, actuation of the actuation portion produces a corresponding movement in the guide portion. In particular embodiments of the invention, actuation of the actuation portion results in pivotal movement of both the actuation portion and the guide portion about the pivot point.

In a preferred embodiment of the invention, the guide portion may be located on the actuation portion. In this embodiment, the guide portion may be located on a rear portion of the actuation portion. The guide portion may be fixedly or removably attached to the rear portion of the actuation portion. By “rear portion” it is meant that the guide portion may be located on a portion of the actuation portion that faces inwardly towards the passageway rather than outwardly towards a user. Preferably, if the elongate member comes into contact with the guide portion as it passes through the passageway, the shape of the guide portion will direct the elongate member towards the engagement portion. In this way, the ease of use of the clasp may be improved.

According to the most preferred embodiment, the actuation portion, the engagement portion and the guide portion will all typically be provided as a single unit albeit, a unit which may include a number of different parts. It is preferred that the guide portion be provided on an underside of the actuation portion and extend down towards an in some instances to the engagement portion in order that the underside of the actuation portion forms the guide portion. It is preferred that the guide portion in this form will be arcuate and will typically form a tapered opening from the first end of the body to a pinch point between the engagement portion and the lower wall of the body.

The guide portion may be provided with any suitable shape. Preferably, however, at least a portion of the surface of the guide portion is curved so as to guide the elongate member towards the engagement portion.

In yet another aspect, the invention resides broadly in a method of attaching a collar to an animal, said collar comprising a clasp and an elongate member, the method comprising the steps of:

actuating an actuation portion located on a clasp provided on said collar, said clasp having a body defining a passageway extending from a first end of the body to a second end of the body, said body comprising one or more walls, the interior of the walls serving to define the passageway,

securing an end of the elongate member to the clasp at the second end of the body of the clasp,

inserting an opposite end of the elongate member into the clasp through an inlet at the first end of the body, the inlet being defined by the body and the actuation portion, toward the second end of the body of the clasp,

releasing the actuation portion when the elongate member has been inserted a sufficient distance into the clasp, wherein

releasing the actuation portion causes an engagement portion to engage with the elongate member, thereby preventing the elongate member from moving when in use.

Additional aspects and/or advantages of the invention will be set forth in part in the description which follows and, in part, will be obvious from the description, or may be learned by practice of the invention.

### BRIEF DESCRIPTION OF THE DRAWINGS

An embodiment of the invention will be described with reference to the following drawings in which:

FIG. 1 illustrates a clasp according to an embodiment of the present invention;

FIG. 2 illustrates a clasp according to an embodiment of the present invention;

FIG. 3 illustrates a clasp according to an embodiment of the present invention;

FIG. 4 illustrates a clasp according to an embodiment of the present invention;

FIGS. 5-7 illustrate a method of using a clasp according to an embodiment of the present invention;

FIG. 8 illustrates a collar according to an embodiment of the present invention;

FIG. 9 illustrates a perspective view of a clasp according to an embodiment of the present invention;

FIG. 10 illustrates a perspective view of a clasp according to an embodiment of the present invention;

FIG. 11 illustrates a cross-sectional view of a clasp according to an embodiment of the present invention;

FIG. 12 illustrates a perspective view of a clasp according to an embodiment of the present invention;

FIG. 13 illustrates an exploded view of a clasp according to an embodiment of the present invention;

FIG. 14 illustrates a perspective view of a clasp according to an embodiment of the present invention;

FIG. 15 illustrates a cross-sectional view of a clasp according to an embodiment of the present invention; and

FIG. 16 illustrates a cross-sectional view of a clasp according to an embodiment of the present invention.

### DETAILED DESCRIPTION OF THE EMBODIMENTS

It will be appreciated that the drawings have been provided for the purposes of illustrating preferred embodiments of the present invention and that the invention should not be considered to be limited solely to the features as shown in the drawings.

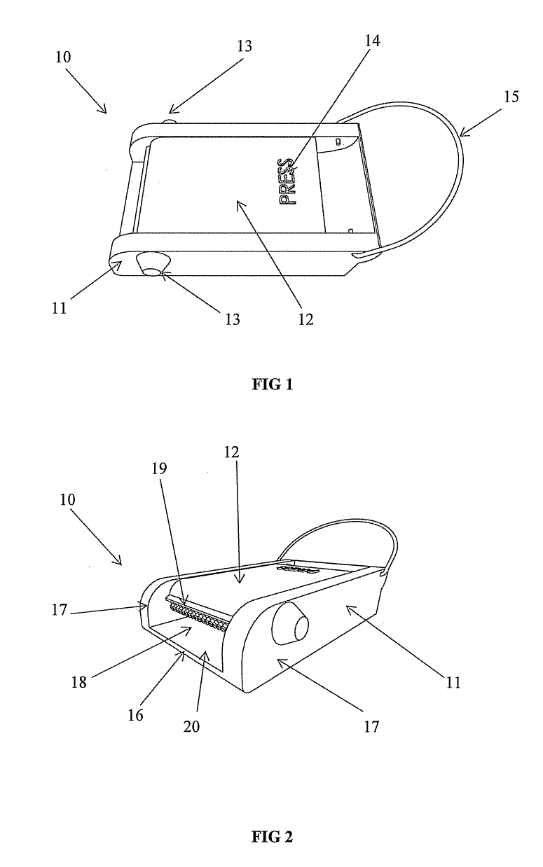

In FIG. 1 there is shown a clasp 10 according to an embodiment of the present invention. The clasp 10 comprises a body 11 and actuation means 12 pivotally attached to the body 11 at a pair of pivot points 13. The actuation means 12 comprises indicia 14 in the form of a word to indicate to the user how the actuation means 12 is operated. The actuation means 12 as shown in FIG. 1 are held in the engaged position by a biasing force applied by biasing means (obscured) in the form of a spring.

The clasp 10 further comprises attachment means in the form of a loop 15 to which another object (such as a leash, identification tag or the like) may be attached.

In FIG. 2 a perspective view of the clasp 10 is shown. In this Figure it may be seen that the body 11 comprises a bottom wall 16 and a pair of sidewalls 17 which extend upwardly from the bottom wall 16. The bottom wall 16 and side walls 17 define a passageway 18 into which an object (not shown) may be inserted. The actuation means 12 serves to define an upper wall of the passageway 18.

In the embodiment of the invention illustrated, the actuation means 12 is provided with engagement means in the form of a plurality of teeth 19, the teeth 19 being adapted to hold and retain an object (not shown) within the passageway 18 adjacent the outlet 20 of the passage way 18.

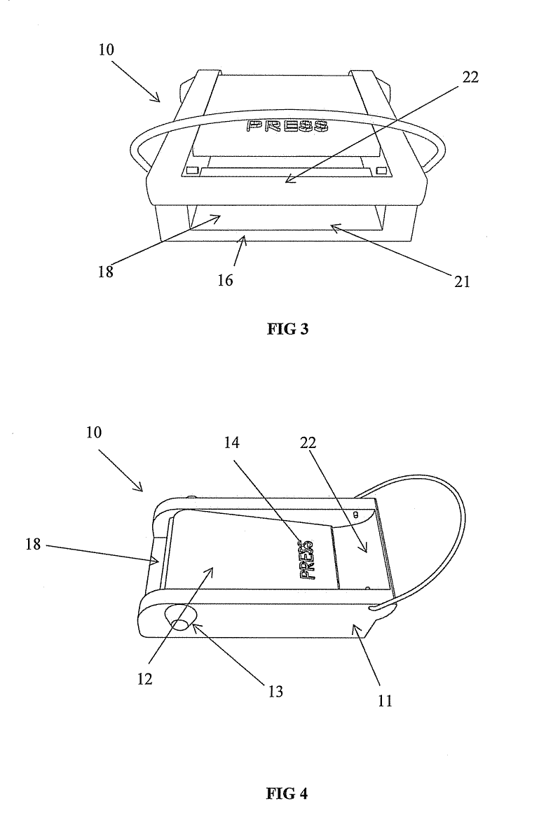

In FIG. 3 the inlet 21 of the passageway 18 may be seen. Guide means 22 are provided across the inlet 21 and extending into the passageway 18 in order to assist a user in guiding an object (not shown) into the passageway 18. The guide means 22 are disposed at an angle to the bottom wall 16 such that the passageway 18 narrows or tapers as it extends into the clasp 10 from the inlet 21.

In FIG. 4, the actuation of the actuation means 12 is illustrated. When a user exerts a downward pressure on a point of the actuation means 12 adjacent the indicia 14, the end of the actuation means 12 closest to the inlet (obscured) of the clasp 10 pivots downwardly towards the guide means 22.

The pivoting of the actuation means 12 around the pivot points 13 causes the engagement means (obscured) to pivot upwardly, thereby removing any obstacles from the passageway 18 and allowing an object (not shown) to be inserted into and through the body 11 of the clasp 10.

Turning now to FIGS. 5 to 7, there is shown the steps in the method of using the clasp 10 according to an embodiment of the invention when it is attached to an elongate member 23, such as a belt, collar, strap or the like.

In FIG. 5, the elongate member 23 is aligned with the inlet (obscured) in preparation for inserting the elongate member 23 into the passageway 18.

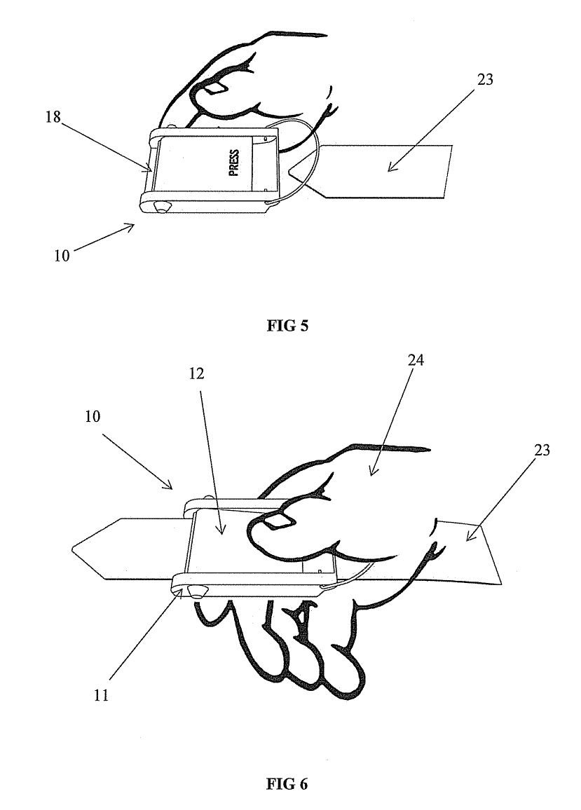

In FIG. 6, a user 24 exerts downward pressure on the actuation means 12 such that the engagement means (obscured) is pivoted upwardly out of the passageway (obscured). The elongate member 23 may now be inserted into the inlet (obscured) and pushed through the body 11 of the clasp 10 along the passageway (obscured) until it exits the clasp 10 through the outlet (obscured).

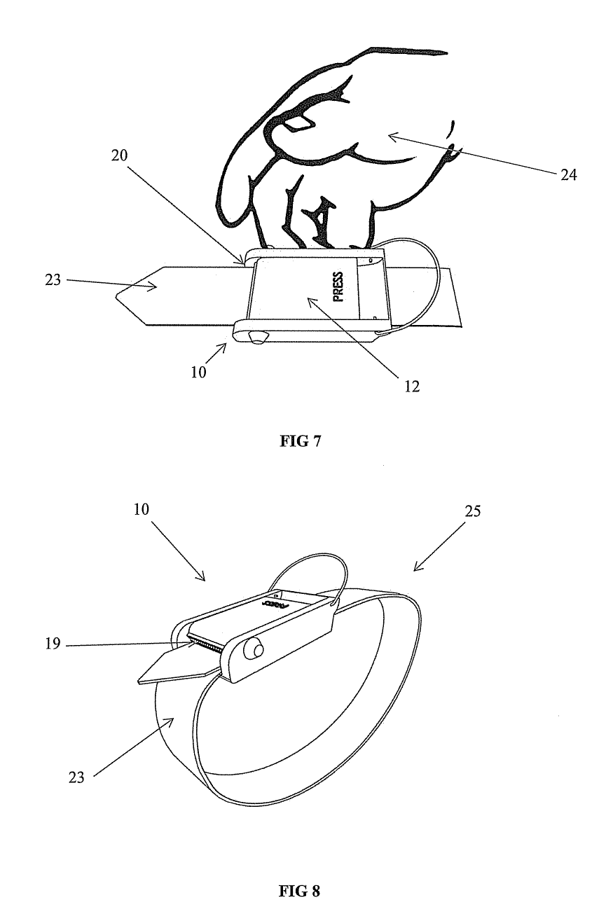

In FIG. 7, the user 24 adjusts the elongate member 23 such that the desired length has been fed through the clasp 10. Once satisfied, the user 24 releases the pressure on the actuation means 12 resulting in the engagement means (obscured) pivoting downwardly to engage and hold the elongate member 23 at a point adjacent the outlet 20. Once in this position, the elongate member 23 cannot move from its position within the clasp 10 due to the strength of the engagement between the engagement means (obscured) and the elongate member 23.

In FIG. 8, an animal collar 25 according to an embodiment of the present invention is shown. The collar 25 includes a clasp 10 and an elongate member 23 which is passed through and held within the clasp 10 by the engagement means 19.

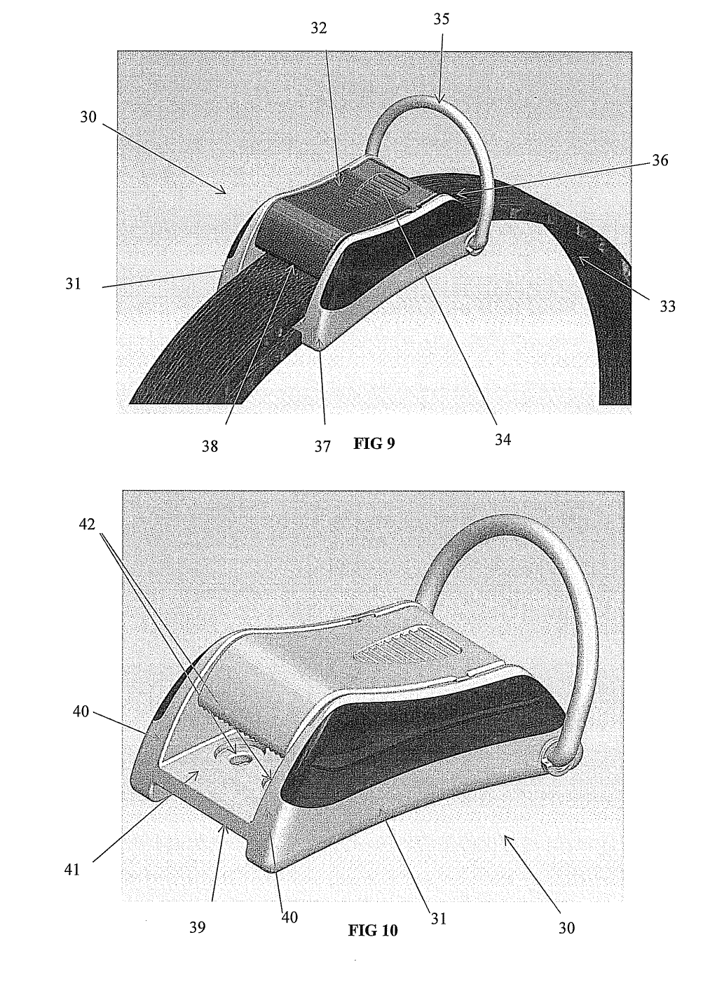

In FIG. 9 there is illustrated a perspective view of a clasp 30 according to an embodiment of the present invention. The clasp 30 comprises a body 31 and an actuation portion 32 pivotally attached to the body 31. The actuation portion 32 comprises indicia 34 in the form of a thumb pad to indicate to the user where to place their thumb (or finger) in order to actuate the actuation portion 32. The actuation portion 32 as shown in FIG. 9 are held in the engaged position by a biasing force applied by a biasing member (obscured) in the form of a spring.

The clasp 30 further comprises an attachment portion in the form of a loop 35 to which another object (such as a leash, identification tag or the like) may be attached.

In FIG. 9, an elongate member 33 in the form of a strap is passed through the body 31 from the inlet end 36 adjacent the actuation portion 32 to the outlet end 37 adjacent the engagement portion 38. It may be seen that, in the engaged position, the engagement portion 38 engages with the elongate member 33 to prevent movement of the elongate member 33 relative to the body 31.

In FIG. 10, a perspective view of the clasp 30 is shown. In this Figure the elongate member is no longer present, allowing a clearer view of the clasp 30 itself. The body 31 of the clasp 30 comprises a substantially continuous bottom wall 39 and a pair of opposed side walls 40 that extend upwardly from the bottom wall 39. The bottom wall 39 and the side walls 40 together define a passageway 41 through the body 31.

The bottom wall 39 comprises a pair of apertures 42 through which a fastener (not shown in this Figure) may be inserted in order to attach the elongate member (not shown in this Figure) to the body 31.

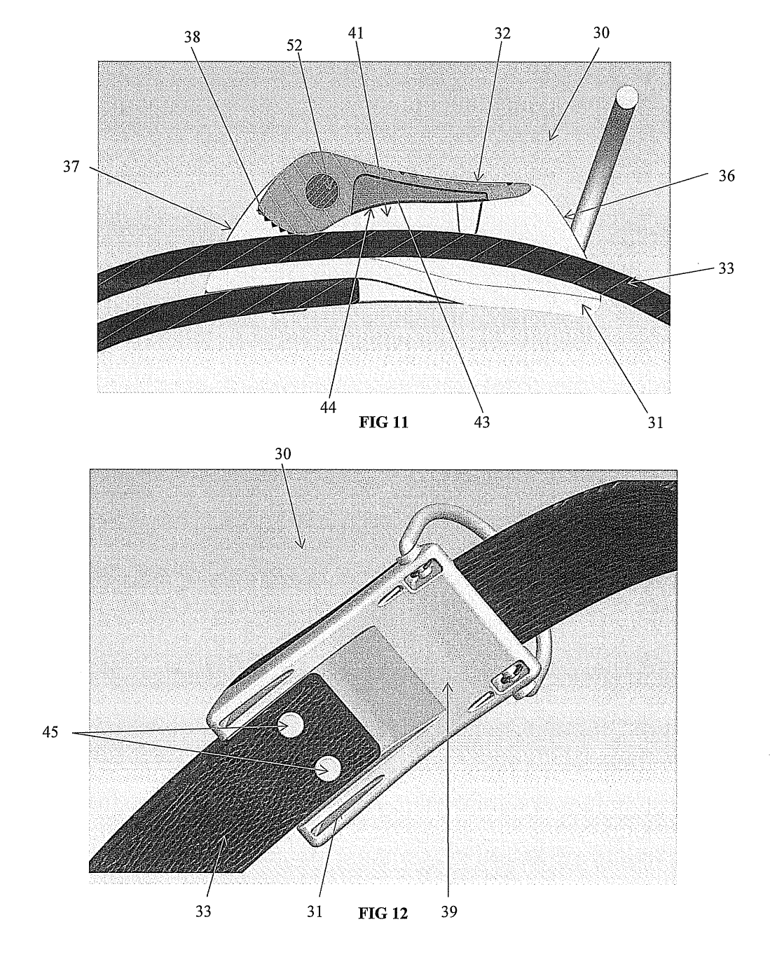

In FIG. 11 a cross-sectional view of the clasp 30 is shown. In this Figure it may be clearly seen that the elongate member 33 is attached to the body 31 at the outlet end 37 of the body 31. The opposite end of the elongate member 33 to that attached to the body 31 is inserted into the passageway 41 at the inlet end 36 of the body 31. The elongate member 33 is passed along the passageway 41 and exits the body 31 through the outlet end 37 thereof.

The actuation portion 32 is shown in the engaged position in which the engagement portion 38 engage the elongate member 33 to prevent its movement relative to the body 31. However, in this Figure the pivot pin 52 may be seen about which the engagement portion 38 and the actuation portion 32 pivot upon actuation of the actuation portion 32.

The guide portion 43 may also be seen in this Figure. The guide portion 43 is located on the side of the actuation portion 32 that faces inwardly towards the passageway 41. The guide portion 43 is provided with a curved outer surface 44 such that, if the elongate member 33 contacts the guide portion 43 as it passes through the passageway 41, the curved surface 44 of the guide portion 43 will direct the elongate member 33 towards the engagement portion 38. This ensures that passing the elongate member 33 through the passageway 41 is relatively simple.

In FIG. 12, a perspective view of the clasp 30 from below may be seen. In this Figure, the fasteners 45 in the form of rivets that attach the elongate member 33 to the bottom wall 39 may be clearly seen.

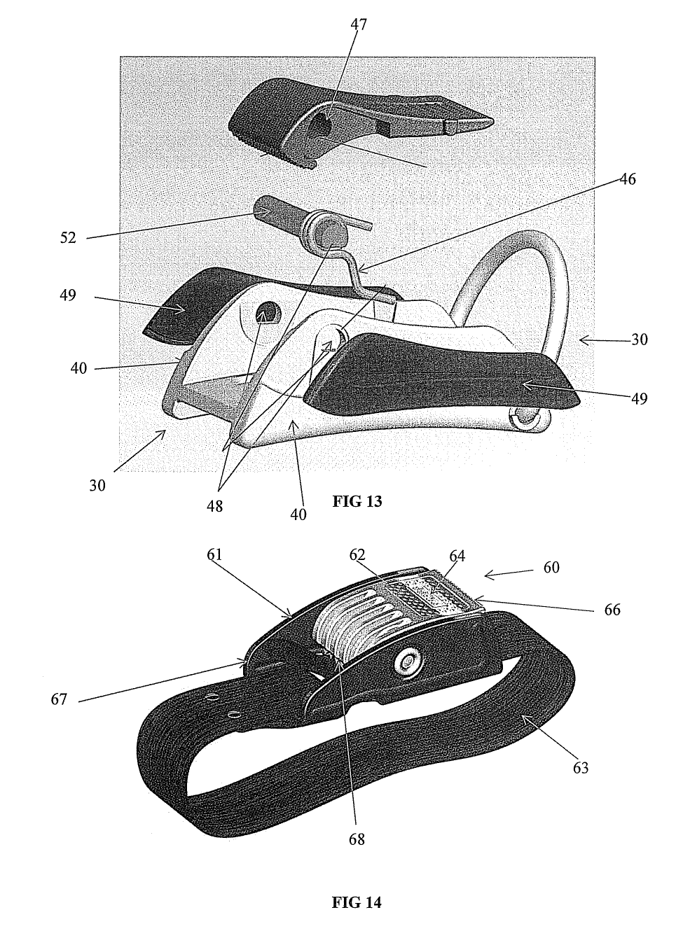

FIG. 13 illustrates an exploded view of the clasp 30 of the present invention. In this Figure, the pivot pin 52 and spring 46 may be seen, along with the aperture 47 in the actuation portion 32 in which the pivot pin 52 is inserted an retained. The pivot pin 52 engages with apertures 48 in the opposed side walls 40. Retention members 49 are positioned on the outer surfaces of the side walls 40 and prevent lateral movement of the pivot pin 52. The retention members 49 may also be fabricated from coloured material so as to provide an aesthetically pleasing finish to the clasp 30.

It is envisaged that the clasp 30 of FIGS. 9 to 13 may be used as, for instance, a clasp for an animal collar, although a skilled addressee will understand that the clasp 30 could be used for any suitable purpose.

In FIG. 14 there is illustrated a perspective view of a clasp 60 according to an alternative embodiment of the present invention. The clasp 60 comprises a body 61 and an actuation portion 62 pivotally attached to the body 61. The actuation portion 62 comprises indicia 64 in the form of a thumb pad to indicate to the user where to place their thumb (or finger) in order to actuate the actuation portion 62. The actuation portion 62 as shown in FIG. 9 is held in the engaged position by a biasing force applied by a biasing member (obscured) in the form of a spring.

In FIG. 14, an elongate member 63 in the form of a strap is passed through the body 61 from the inlet end 66 adjacent the actuation portion 62 to the outlet end 67 adjacent the engagement portion 68. It may be seen that, in the engaged position, the engagement portion 68 engages with the elongate member 33 to prevent movement of the elongate member 63 relative to the body 61.

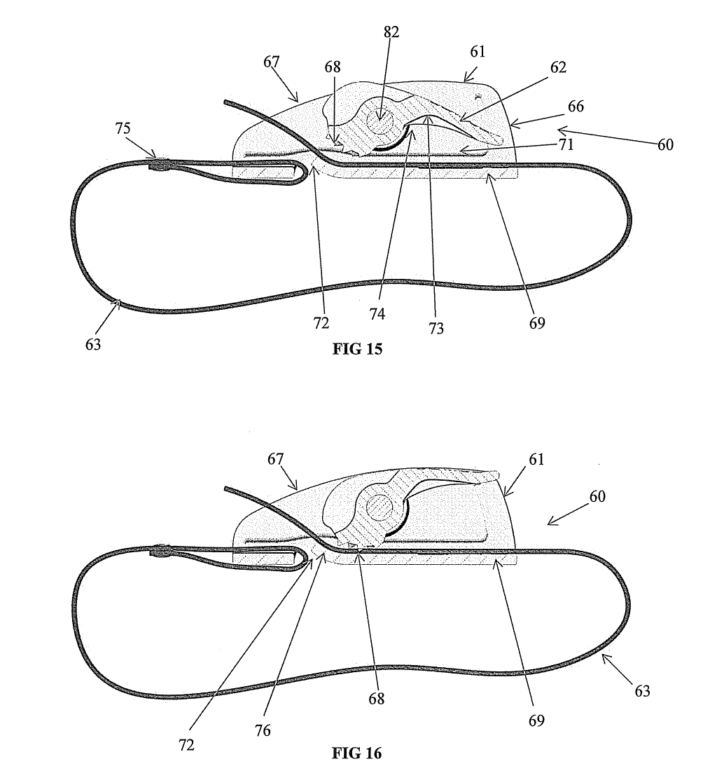

In FIG. 15 a cross-sectional view of the clasp 60 is shown. In this Figure it may be clearly seen that the elongate member 63 is attached to the body 61 at the outlet end 67 of the body 61. The elongate member 63 is attached to the body by passing a section of the elongate member 63 through an aperture 72 in the bottom wall 69 of the body 61. The elongate member 63 is then folded back on itself to form a loop and the looped end is secured to the elongate member 63 by a fastener 75.

The opposite end of the elongate member 63 to that attached to the body 61 is inserted into the passageway 71 at the inlet end 66 of the body 61. The elongate member 63 is passed along the passageway 61 and exits the body 61 through the outlet end 67 thereof.

The actuation portion 62 is shown in the disengaged position in which the engagement portion 68 is moved out of engagement with the elongate member 63 to allow its movement relative to the body 61 (withdrawal of the elongate member 63, insertion of the elongate member 63, or adjusting the position of the elongate member 63 relative to the body 61). In this Figure the pivot pin 82 may be seen about which the engagement portion 68 and the actuation portion 62 pivot upon actuation of the actuation portion 62.

The guide portion 73 may also be seen in this Figure. The guide portion 73 is located on the side of the actuation portion 62 that faces inwardly towards the passageway 71. The guide portion 73 is provided with a curved outer surface 74 such that, if the elongate member 63 contacts the guide portion 73 as it passes through the passageway 71, the curved surface 74 of the guide portion 73 will direct the elongate member 63 towards the engagement portion 68. This ensures that passing the elongate member 63 through the passageway 71 is relatively simple.

In FIG. 16, a cross-sectional view of the clasp 60 is shown. In this Figure, the engagement portion 68 is shown in the engaged position in which the engagement portion 68 is engaged with the elongate member 63 so as to prevent movement of the elongate member 63 relative to the body 61.

In this Figure it may be seen that the bottom wall 69 is provided with a curved portion 76 adjacent the aperture 72. This curved portion 76 ensures that, as the elongate member 63 passes along the passageway 71, the elongate member 63 is directed towards the outlet 67 of the body 61. This assists in preventing the elongate member 63 from passing through the aperture 72 in the bottom wall 69.

It is envisaged that the clasp 60 of FIGS. 14 to 16 may be used as, for instance, a clasp for a tie down (such as those used to secure a load on a truck or similar vehicle), although a skilled addressee will understand that the clasp 60 could be used for any suitable purpose.

Those skilled in the art will appreciate that the present invention may be susceptible to variations and modifications other than those specifically described. It will be understood that the present invention encompasses all such variations and modifications that fall within its spirit and scope.

What is claimed is:

1. A clasp having:
a body defining at least one passageway extending from an inlet at a first end of the body to an outlet at a second, opposite end of the body, the second end of the body adapted to secure an elongate member to the body of the clasp, said body comprising a bottom wall, one or more walls extending upward from said bottom wall, the interior of the one or more walls serving to define the passageway,
an engagement portion pivotally mounted across the body and adapted to engage the elongate member when located in said at least one passageway,
an actuation portion in communication with the engagement portion and biased into an engaged condition,
wherein actuation of said actuation portion causes the engagement portion to disengage from the elongate member against the biasing force.

2. A clasp according to claim 1 wherein the engagement portion is connected to the actuation portion and comprises one or more projections that engage with the elongate member when in use.

3. A clasp according to claim 1 wherein actuating the actuation portion causes the engagement portion to disengage from the elongate member.

4. A clasp according to claim 1 wherein the elongate member comprises one or more belts, straps, cords, ropes or chains.

5. A clasp according to claim 1 wherein the bottom wall is substantially continuous.

6. A clasp according to claim 1 wherein the bottom wall is non-continuous.

7. A clasp according to claim 6 wherein at least a portion of the bottom wall is shaped so as to guide the elongate member through the passageway.

8. A clasp according to claim 7 wherein the at least a portion of the bottom wall is angled into the passageway.

9. A clasp according to claim 1 wherein the clasp is provided with a guide portion associated with the actuation portion.

10. A clasp according to claim 9 wherein the guide portion is shaped so as to direct the elongate member towards the engagement portion.

11. A method of attaching a collar to an animal, said collar comprising a clasp and an elongate member, the method comprising the steps of:
actuating an actuation portion located on a clasp provided on said collar, said clasp having a body defining a passageway extending from a first end of the body to a second end of the body, said body comprising one or more walls, the interior of the walls serving to define the passageway,
securing an end of the elongate member to the clasp at the second end of the body of the clasp,
inserting an opposite end of the elongate member into the clasp through an inlet at the first end of the body, the inlet being defined by the body and the actuation portion, toward the second end of the body of the clasp,
releasing the actuation portion when the elongate member has been inserted a sufficient distance into the clasp, wherein
releasing the actuation portion causes an engagement portion to engage with the elongate member, thereby preventing the elongate member from moving when in use.
